(19) United States
(12) Patent Application Publication
(10) Pub. No.: US 2010/0017655 A1
(43) Pub. Date: Jan. 21, 2010

(54) Error Recovery During Execution Of An Application On A Parallel Computer

(75) Inventors: Thomas M. GOODING, Rochester, MN (US); Patrick J. MCCARTHY, Rochester, MN (US); Michael B. MUNDY, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARKMONK, NY (US)

(21) Appl. No.: 12/174,312

(22) Filed: Jul. 16, 2008

(51) Int. Cl. G06F 11/08

(52) U.S. Cl. 714/16; 714/E11.03

(57) ABSTRACT

Methods, apparatus, and products are disclosed for error recovery during execution of an application on a parallel computer that includes a plurality of compute nodes. Such error recovery includes: storing, by the application during execution on the nodes, application restore data in a restore buffer at predetermined points during execution of the application, the restore data specifying an execution state of the application at one or more points during application execution; encountering, by at least one of the nodes executing the application, a recoverable error during application execution; determining, by the application, the nodes affected by the recoverable error; restarting, by each of the affected nodes, execution of the application; retrieving, by the restarted application executing on each of the affected nodes, the restore data from the restore buffer; and continuing, by each affected node, execution of the application with the execution state specified by the retrieved restore data.

### BACKGROUND OF THE INVENTION

1. Field of the Invention

The field of the invention is data processing, or, more specifically, methods, apparatus, and products for error recovery during execution of an application on a parallel computer.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances.

Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory need for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x,y,z coordinate in the mesh. In such a manner, a torus network lends itself to point to point operations. In a tree network, the nodes typically are organized in a binary tree arrangement: each node has a parent and two children (although some nodes may only have zero children or one child, depending on the hardware configuration). In computers that use a torus and a tree network, the two networks typically are implemented independently of one another, with separate routing circuits, separate physical links, and separate message buffers. A tree network provides high bandwidth and low latency for certain collective operations, such as, for example, an allgather, allreduce, broadcast, scatter, and so on.

Using such data communications networks, a parallel computer may connect a large number of compute nodes to provide processing resources to execute an application. As the number of compute nodes used to process an application increases, the recoverable error rate also increases, which can drastically decrease the ability of the parallel computer to execute the application. A single recoverable error such as, for example, certain parity errors, on a single compute node may cause execution of the entire application to fail. In such situations, the system administrator must restart application execution from the beginning on all of the compute nodes. In other situations, a recoverable error may only require that the system administrator restart application execution from the beginning on the compute node on which the error occurred. Regardless, restarting execution of the application from the beginning wastes valuable time and computing resources.

### SUMMARY OF THE INVENTION

Methods, apparatus, and products are disclosed for error recovery during execution of an application on a parallel computer. The parallel computer includes a plurality of compute nodes. Error recovery during execution of an application on a parallel computer includes: storing, by the application during execution on the compute nodes, application restore data in a restore buffer at predetermined points during execution of the application, the application restore data specifying an execution state of the application at one or more points during execution of the application; encountering, by at least one of the compute nodes executing the application, a recoverable error during execution of the application; determining, by the application, the compute nodes affected by the recoverable error; restarting, by each of the affected compute nodes, execution of the application; retrieving, by the restarted application executing on each of the affected compute nodes, the application restore data from the restore buffer; and continuing, by each affected compute node, execution of the application with the execution state specified by the retrieved application restore data.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary system for error recovery during execution of an application on a parallel computer according to embodiments of the present invention.

FIG. 2 sets forth a block diagram of an exemplary compute node useful in a parallel computer capable of error recovery during execution of an application on a parallel computer according to embodiments of the present invention.

FIG. 3A illustrates an exemplary Point To Point Adapter useful in systems capable of error recovery during execution of an application on a parallel computer according to embodiments of the present invention.

FIG. 3B illustrates an exemplary Global Combining Network Adapter useful in systems capable of error recovery during execution of an application on a parallel computer according to embodiments of the present invention.

FIG. 4 sets forth a line drawing illustrating an exemplary data communications network optimized for point to point operations useful in systems capable of error recovery during execution of an application on a parallel computer in accordance with embodiments of the present invention.

FIG. 5 sets forth a line drawing illustrating an exemplary data communications network optimized for collective operations useful in systems capable of error recovery during execution of an application on a parallel computer in accordance with embodiments of the present invention.

FIG. 6 sets forth a flow chart illustrating an exemplary method for error recovery during execution of an application on a parallel computer according to the present invention.

### DETAILED DESCRIPTION OF EXEMPLARY EMBODIMENTS

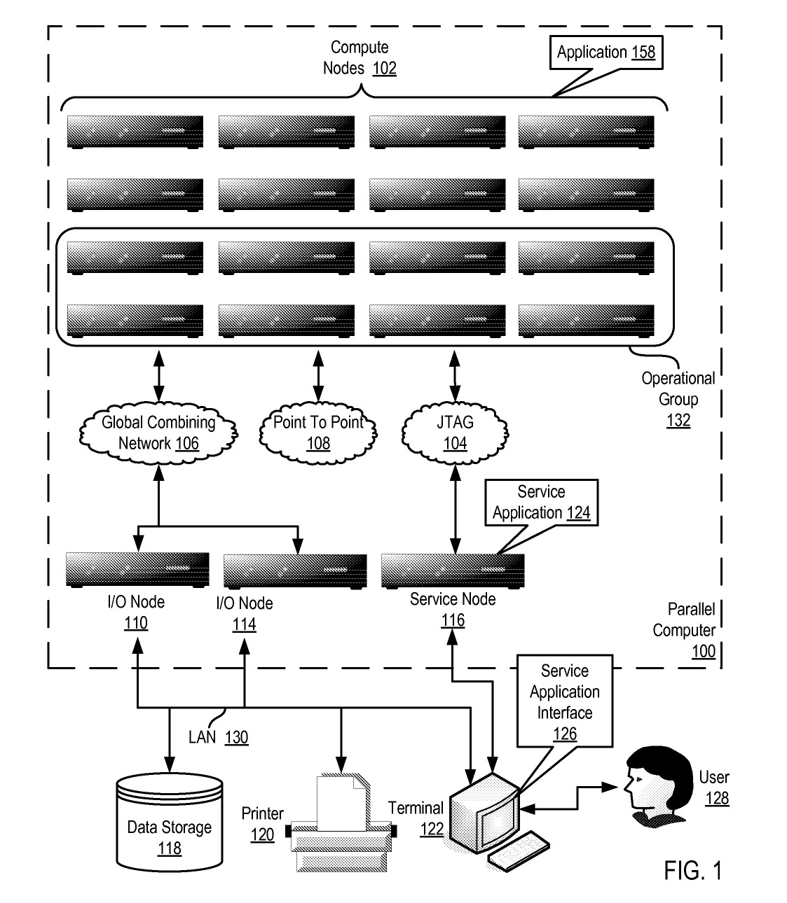

Exemplary methods, apparatus, and computer program products for error recovery during execution of an application on a parallel computer according to embodiments of the present invention are described with reference to the accompanying drawings, beginning with FIG. 1. FIG. 1 illustrates an exemplary system for error recovery during execution of an application on a parallel computer according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102) that execute an application. The application is a set of computer program instructions that provide user-level data processing.

Each compute node (102) of FIG. 1 may include a plurality of processors for use in executing an application on the parallel computer (100) according to embodiments of the present invention. The processors of each compute node (102) in FIG. 1 are operatively coupled to computer memory such as, for example, random access memory (‘RAM’). Each compute node (102) may operate in several distinct modes that affect the relationship among the processors and the memory on that node such as, for example, serial processing mode or parallel processing mode. The mode in which the compute nodes operate is generally set during the node's boot processes and does not change until the node reboots.

In serial processing mode, often referred to a ‘virtual node mode,’ the processors of a compute node operate independently of one another, and each processor has access to a partition of the node's total memory that is exclusively dedicated to that processor. For example, if a compute node has four processors and two Gigabytes (GB) of RAM, when operating in serial processing mode, each processor may process a thread independently of the other processors on that node, and each processor may access a 512 Megabyte (MB) portion of that node's total 2 GB of RAM.

In parallel processing mode, often referred to as ‘symmetric multi-processing mode,’ one of the processors acts as a master, and the remaining processors serve as slaves to the master processor. Each processor has access to the full range of computer memory on the compute node. Continuing with the exemplary node above having four processors and 2 GB of RAM, for example, each slave processor may cooperatively process threads spawned from the master processor, and all of the processors have access to the node's entire 2 GB of RAM. The compute nodes (102) are coupled for data communications by several independent data communications networks including a Joint Test Action Group (‘JTAG’) network (104), a global combining network (106) which is optimized for collective operations, and a torus network (108) which is optimized point to point operations. The global combining network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer. The links between compute nodes are bidirectional links that are typically implemented using two separate directional data communications paths.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operation for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for use with systems according to embodiments of the present invention include MPI and the ‘Parallel Virtual Machine’ (‘PVM’) library. PVM was developed by the University of Tennessee, The Oak Ridge National Laboratory, and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group. For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

In a scatter operation, the logical root divides data on the root into segments and distributes a different segment to each compute node in the operational group. In scatter operation, all processes typically specify the same receive count. The send arguments are only significant to the root process, whose buffer actually contains sendcount * N elements of a given data type, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, the parallel computer (100) includes input/output (‘I/O’) nodes (110, 114) coupled to compute nodes (102) through the global combining network (106). The compute nodes in the parallel computer (100) are partitioned into processing sets such that each compute node in a processing set is connected for data communications to the same I/O node. Each processing set, therefore, is composed of one I/O node and a subset of compute nodes (102). The ratio between the number of compute nodes to the number of I/O nodes in the entire system typically depends on the hardware configuration for the parallel computer. For example, in some configurations, each processing set may be composed of eight compute nodes and one I/O node. In some other configurations, each processing set may be composed of sixty-four compute nodes and one I/O node. Such example are for explanation only, however, and not for limitation. Each I/O nodes provide I/O services between compute nodes (102) of its processing set and a set of I/O devices. In the example of FIG. 1, the I/O nodes (110, 114) are connected for data communications I/O devices (118, 120, 122) through local area network (‘LAN’) (130) implemented using high-speed Ethernet.

The parallel computer (100) of FIG. 1 also includes a service node (116) coupled to the compute nodes through one of the networks (104). Service node (116) provides services common to pluralities of compute nodes, administering the configuration of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

As described in more detail below in this specification, the system of FIG. 1 operates generally for error recovery during execution of an application on a parallel computer (100) according to embodiments of the present invention. The system of FIG. 1 operates generally for error recovery during execution of an application on a parallel computer according to embodiments of the present invention as follows: The application (158), during execution on the compute nodes (102), stores application restore data in a restore buffer at predetermined points during execution of the application. The application restore data specifies an execution state of the application at one or more points during execution of the application. At least one of the compute nodes executing the application encounters a recoverable error during execution of the application. The application determines the compute nodes affected by the recoverable error. Each of the affected compute nodes then restarts execution of the application. The restarted application executing on each of the affected compute nodes retrieves the application restore data from the restore buffer. Each affected compute node continues execution of the application with the execution state specified by the retrieved application restore data.

Application restore data is execution state information or the information used to reconstruct the execution state of an application at one or more points during execution of the application. The execution state of an application refers to the contents of hardware registers, cache, computer memory, or the like used by or on behalf of the application at a particular point during the application's execution. For example, the execution state may include the contents of the process control block utilized by an operating system to schedule the application for execution on the processor of a compute node. The execution state may include the contents of registers and cache utilized by the processor during execution of the application. The execution state may also include contents of memory that store run-time variable values. Readers will note that because each of the compute nodes (102) typically executes its own instance of the application (158), each compute node (102) may have its own restore buffer to store the application restore data for the instance of the application (158) executing on that compute node.

A recoverable error is an error that can be corrected by resetting computer hardware to a known state. Such a known state may include the computer hardware's power-on state or any other state as will occur to those of skill in the art. An example of a recoverable error may include a parity error due to a stray alpha particle that changes the value of a bit in computer memory. A recoverable error may be contrasted with an unrecoverable error in that an unrecoverable error usually involves a hardware failure that is correctable only by replacing or repairing a hardware component.

In the example of FIG. 1, the plurality of compute nodes (102) are implemented in a parallel computer (100) and are connected together using a plurality of data communications networks (104, 106, 108). The point to point network (108) is optimized for point to point operations. The global combining network (106) is optimized for collective operations.

The arrangement of nodes, networks, and I/O devices making up the exemplary system illustrated in FIG. 1 are for explanation only, not for limitation of the present invention. Data processing systems capable of error recovery during execution of an application on a parallel computer according to embodiments of the present invention may include additional nodes, networks, devices, and architectures, not shown in FIG. 1, as will occur to those of skill in the art. Although the parallel computer (100) in the example of FIG. 1 includes sixteen compute nodes (102), readers will note that parallel computers capable of error recovery during execution of an application on a parallel computer according to embodiments of the present invention may include any number of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

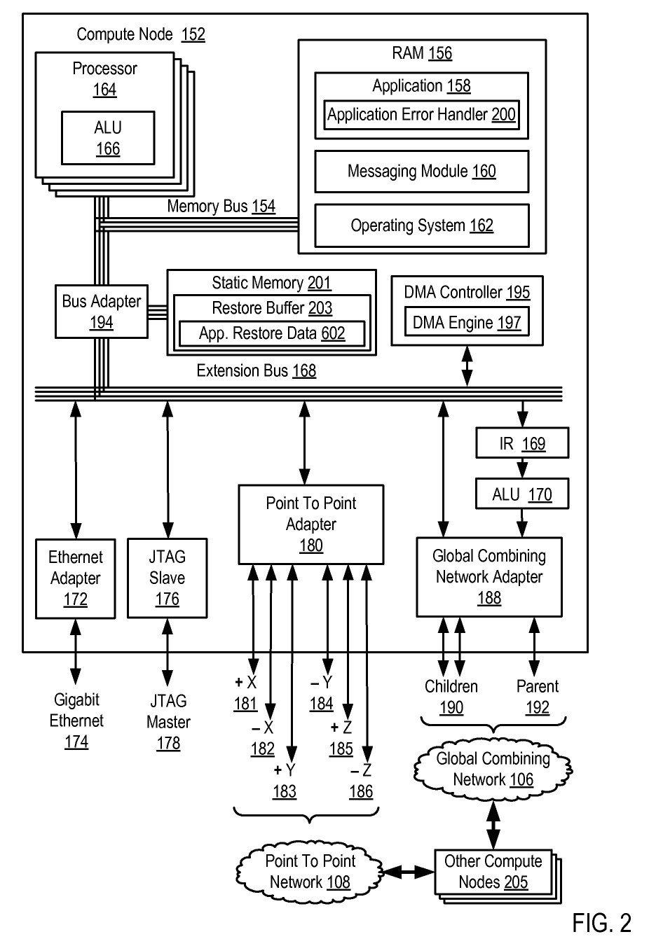

Error recovery during execution of an application on a parallel computer according to embodiments of the present invention may be generally implemented on a parallel computer that includes a plurality of compute nodes. In fact, such computers may include thousands of such compute nodes. Each compute node is in turn itself a kind of computer composed of one or more computer processors, its own computer memory, and its own input/output adapters. For further explanation, therefore, FIG. 2 sets forth a block diagram of an exemplary compute node useful in a parallel computer capable of error recovery during execution of an application on a parallel computer according to embodiments of the present invention. The parallel computer includes a plurality of compute nodes (152, 205). The compute node (152) of FIG. 2 includes one or more computer processors (164) as well as random access memory (‘RAM’) (156). The processors (164) are connected to RAM (156) through a high-speed memory bus (154) and through a bus adapter (194) and an extension bus (168) to other components of the compute node (152). Stored in RAM (156) is an application program (158), a module of computer program instructions that carries out parallel, user-level data processing using parallel algorithms.

The parallel computer, which includes the compute node (152) of FIG. 2, operates generally for error recovery during execution of the application (158) on a parallel computer according to embodiments of the present invention: The application (158), during execution on the compute nodes (152, 205) of the parallel computer, stores application restore data (602) in a restore buffer (203) at predetermined points during execution of the application (158). The application restore data (602) specifies an execution state of the application (158) at one or more points during execution of the application (158). At least one of the compute nodes (152) in the parallel computer executing the application (158) encounters a recoverable error during execution of the application (158). The application (158) determines the compute nodes (152) affected by the recoverable error. Each of the affected compute nodes (152) restarts execution of the application (158). The restarted application (158) executing on each of the affected compute nodes (152) retrieves the application restore data (602) from the restore buffer (203). Each affected compute node (152) continues execution of the application (158) with the execution state specified by the retrieved application restore data (602).

The restore buffer (203) of FIG. 2 is an application data structure created by the application (158) to store application restore data (602). The application (158) may create the restore buffer (203) as part of the initialization process when the application (158) starts up provided that the restore buffer (203) does not already exist. The restore buffer (203) may already exist because the buffer (203) was never deallocated when the application (158) was previously executed by the compute node (152) due to an error encountered during execution. If during the application's initialization process the application (158) determines that the restore buffer (203) exists, then the application (158) retrieves the application restore data (602) and continues execution of the application (158) with the execution state specified by the retrieved application restore data (602). In such a manner, readers will note that the restore buffer (203) is a persistent application data structure that may be utilized by different instances of the application (158) executed at different times on the compute node (152).

To provide a persistent restore buffer (203), the application (158) registers a buffer identifier specifying the location of the restore buffer (203) with the operating system (162) using a function of the operating system's application programming interface (‘API’). When the application (158) is restarted, the application (158) may request the location of the restore buffer (203) from the operating system (162) using a function of the operating system's API. If execution of the application (158) was terminated prematurely due to an error, then the operating system (162) is able to provide the application (158) with the buffer identifier for the restore buffer (203) because the buffer (203) was never deallocated by the application (158). If however, execution of the application (158) ended normally without error, then the application (158) would have deallocated the restore buffer (203) in memory and deregistered the restore buffer (203) with the operating system (162) before execution ended. Upon restarting the application (158), the operating system (162) may return a ‘NULL’ value for the buffer identifier, thereby signaling the application (158) to continue execution without reconfiguring its execution state using any application restore data.

Because the application restore data (602) is typically the only data available for the application (158) to use when restarting from recoverable errors, any measures taken to enhance reliability and availability of the application restore data (602) is useful. In the example of FIG. 2, therefore, the restore buffer (203) is located in static memory (201). The static memory (201) of FIG. 2 is computer memory that does not need to be periodically refreshed, thereby reducing the potential of data corruption due to an error in the refresh process. The static memory (201) of FIG. 2 may be volatile or non-volatile. Examples of static memory (201) may include Static RAM (‘SRAM’), Electrically Erasable Programmable Read-Only Memory (‘EEPROM’), or others as will occur to those of skill in the art.

In the example of FIG. 2, the application (158) includes an application error handler (200). The application error handler (200) of FIG. 2 identifies an error that occurs during application execution and performs various tasks in response to the error. These tasks may include notifying a user of the application of the error, attempting to correct the error, ignoring the error, and so on. The application (158) registers the application error handler (200) with the operating system (162) during the initialization process when execution of the application (158) begins.

When the compute node (152) encounters a recoverable error while executing the application (158) in the example of FIG. 2, the operating system (162) of the compute node (152) invokes the application error handler (200) to determine all of the compute nodes (152) that may be affected by the recoverable error. The application error handler (200) of FIG. 2 may then instruct the operating system (162) on the compute node (152) to restart execution of the application (158) on the compute node (152) and notify the operating systems of any other affected compute nodes to restart execution of the application on those compute nodes. Before restarting application execution, however, the affected compute nodes may reset all of the hardware components affected by the recoverable error.

As mentioned above, when application execution is restarted, the application (158) of FIG. 2 requests the location of the restore buffer (203) from the operating system (162) using a function of the operating system's API. The operating system (162), in turn, provides the application (158) with the location of the restore buffer (203). The restarted application (158) then retrieves the application restore data (602) from the restore buffer (203) and continues execution of the application (158) with the execution state specified by the retrieved application restore data (602).

Also stored in RAM (156) is a messaging module (160), a library of computer program instructions that carry out parallel communications among compute nodes, including point to point operations as well as collective operations. Application program (158) executes collective operations by calling software routines in the messaging module (160). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is the operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX·, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in systems for error recovery during execution of an application on a parallel computer according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in error recovery during execution of an application on a parallel computer according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Global Combining Network Adapter (188) that couples example compute node (152) for data communications to a network (106) that is optimal for collective message passing operations on a global combining network configured, for example, as a binary tree. The Global Combining Network Adapter (188) provides data communications through three bidirectional links: two to children nodes (190) and one to a parent node(192).

Example compute node (152) includes two arithmetic logic units (‘ALUs’). ALU (166) is a component of processor (164), and a separate ALU (170) is dedicated to the exclusive use of Global Combining Network Adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, Global Combining Network Adapter (188) may execute the arithmetic or logical operation by use of ALU (166) in processor (164) or, typically much faster, by use dedicated ALU (170).

The example compute node (152) of FIG. 2 includes a direct memory access (‘DMA’) controller (195), which is computer hardware for direct memory access and a DMA engine (195), which is computer software for direct memory access. Direct memory access includes reading and writing to memory of compute nodes with reduced operational burden on the central processing units (164). A DMA transfer essentially copies a block of memory from one location to another, typically from one compute node to another. While the CPU may initiate the DMA transfer, the CPU does not execute the transfer.

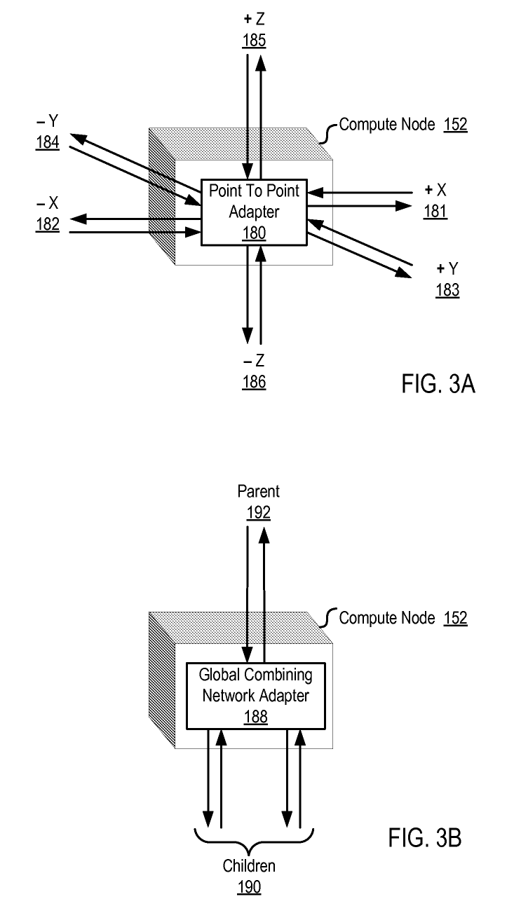

For further explanation, FIG. 3A illustrates an exemplary Point To Point Adapter (180) useful in systems capable of error recovery during execution of an application on a parallel computer according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in FIG. 3A also provides data communication along a z-axis through four unidirectional data communications links, to and from the next node in the −z direction (186) and to and from the next node in the +z direction (185).

For further explanation, FIG. 3B illustrates an exemplary Global Combining Network Adapter (188) useful in systems capable of error recovery during execution of an application on a parallel computer according to embodiments of the present invention. Global Combining Network Adapter (188) is designed for use in a network optimized for collective operations, a network that organizes compute nodes of a parallel computer in a binary tree. Global Combining Network Adapter (188) in the example of FIG. 3B provides data communication to and from two children nodes through four unidirectional data communications links (190). Global Combining Network Adapter (188) also provides data communication to and from a parent node through two unidirectional data communications links (192).

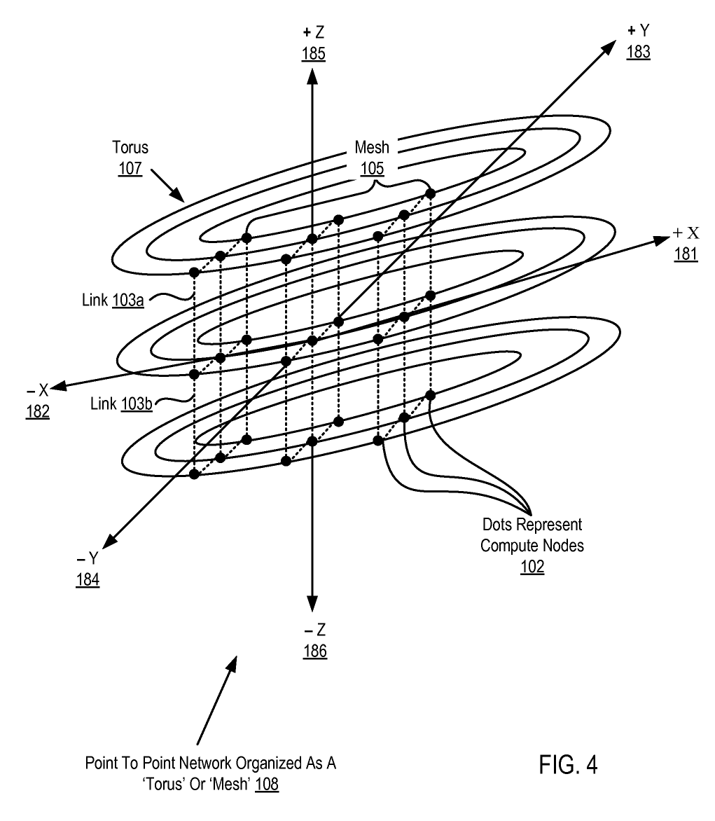

For further explanation, FIG. 4 sets forth a line drawing illustrating an exemplary data communications network (108) optimized for point to point operations useful in systems capable of error recovery during execution of an application on a parallel computer in accordance with embodiments of the present invention. In the example of FIG. 4, dots represent compute nodes (102) of a parallel computer, and the dotted lines between the dots represent data network links (103) between compute nodes. The networks links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105). The mesh (105) has wrap-around links on each axis that connect the outermost compute nodes in the mesh (105) on opposite sides of the mesh (105). These wrap-around links form part of a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point to point operations for use in error recovery during execution of an application on a parallel computer in accordance with embodiments of the present invention may contain only a few compute nodes or may contain thousands of compute nodes.

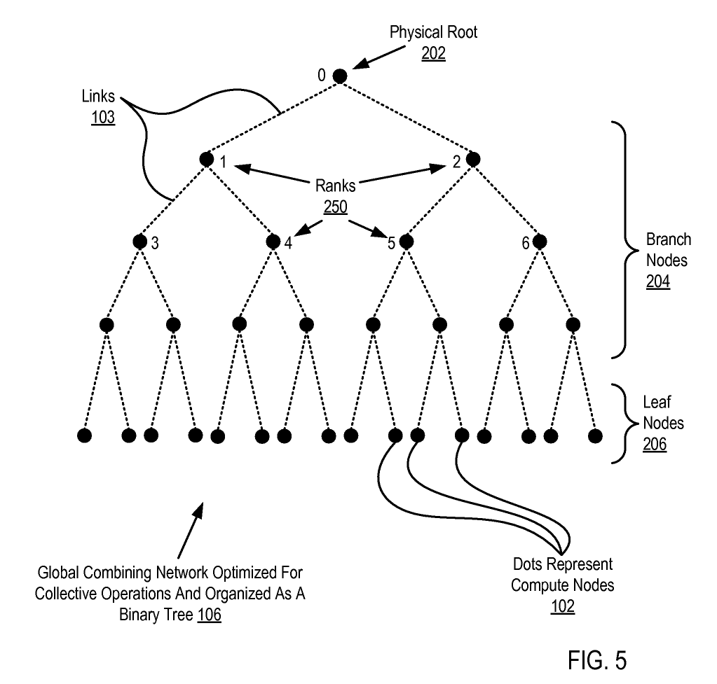

For further explanation, FIG. 5 sets forth a line drawing illustrating an exemplary data communications network (106) optimized for collective operations useful in systems capable of error recovery during execution of an application on a parallel computer in accordance with embodiments of the present invention. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in a binary tree (106) may be characterized as a physical root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a data communications network optimized for collective operations for use in systems for error recovery during execution of an application on a parallel computer accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

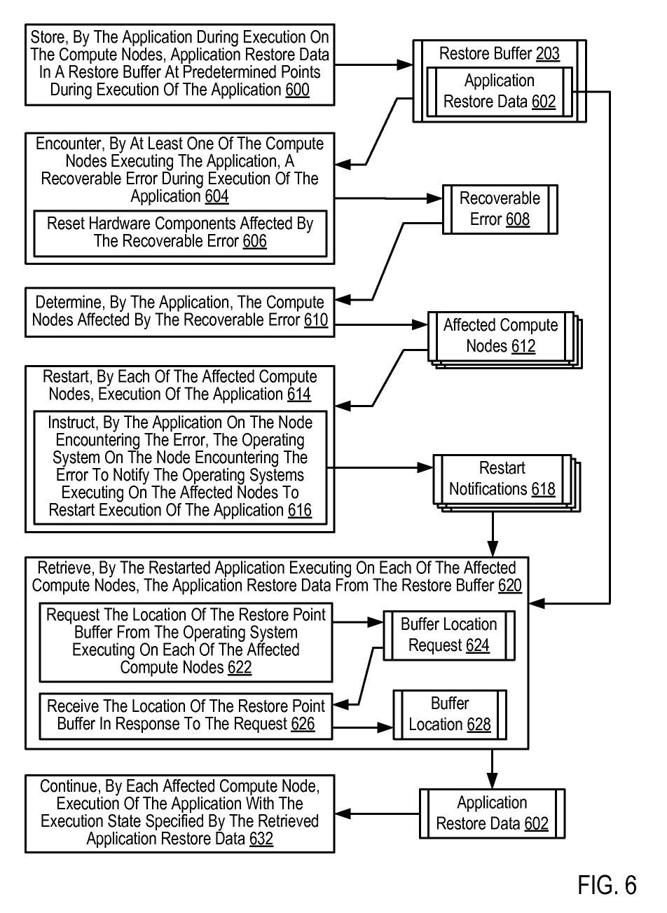

For further explanation, FIG. 6 sets forth a flow chart illustrating an exemplary method for error recovery during execution of an application on a parallel computer according to the present invention. The parallel computer described with reference to FIG. 6 includes a plurality of compute nodes. The plurality of compute nodes are connected together using a plurality of data communications networks. At least one of the data communications networks is optimized for point to point operations. At least one of the data communications networks is optimized for collective operations.

The method of FIG. 6 includes storing (600), by the application during execution on the compute nodes, application restore data (602) in a restore buffer (203) at predetermined points during execution of the application. The application restore data (602) of FIG. 6 represents execution state information or the information used to reconstruct the execution state of the application at one or more points during execution of the application. As mentioned above, the execution state of an application refers to the contents of hardware registers, cache, computer memory, or the like used by or on behalf of the application at a particular point during the application's execution.

The application may store (600) the application restore data (602) in the restore buffer (203) according to the method of FIG. 6 by retrieving the contents of hardware registers, cache, computer memory, and the like used to execute the application and write the retrieved contents into the restore buffer (203) as the application restore data (602). To reduce the overall size of the application restore data (602) stored in the restore buffer (203) in the example of FIG. 6, the application may first compress the contents of hardware registers, cache, computer memory, and the like used to execute the application using any data compression algorithm as will occur to those of skill in the art such as, for example, run-length encoding algorithms, dictionary coding algorithms, Huffman coding algorithms, dynamic Markov compression, and so on.

The method of FIG. 6 also includes encountering (604), by at least one of the compute nodes executing the application, a recoverable error (608) during execution of the application. The recoverable error (608) of FIG. 6 represents an error that can be corrected by resetting computer hardware to a known state. Such a known state may include the computer hardware's power-on state or any other state as will occur to those of skill in the art. An example of a recoverable error may include a parity error due to a stray alpha particle that changes the value of a bit in computer memory. Encountering (604), by at least one of the compute nodes executing the application, a recoverable error (608) during execution of the application according to the method of FIG. 6 includes resetting (606) hardware components affected by the recoverable error (608). The compute node encountering the recoverable error (608) may reset (606) hardware components affected by the recoverable error (608) according to the method of FIG. 6 by cycling the power to those affected hardware components.

Encountering (604), by at least one of the compute nodes executing the application, a recoverable error (608) during execution of the application according to the method of FIG. 6 may also include invoking the application's error handler in response to detecting the recoverable error. The compute node encountering the recoverable error (608) may invoke the application's error handler through the compute node's operating system. As mentioned above, the compute node may register the application's error handler with the operating system during the initialization process when application execution begins. Upon invoking the application's error handler, the operating system of the compute node may provide the application error handler with a signal indicating that the error occurring is a recoverable error.

The method of FIG. 6 includes determining (610), by the application, the compute nodes (612) affected by the recoverable error (608). The error handler of the application may determine (610) the compute nodes (612) affected by the recoverable error (608) according to the method of FIG. 6 by identifying the point during execution at which the recoverable error (608) is encountered and identifying the affected compute nodes (612) based on the point during execution at which the recoverable error (608) is encountered. For example, the application error handler may determine that the application on a particular compute node was performing a local calculation immediately before a barrier operation when the compute node encountered the recoverable error. In such an example, the application error handler may determine that only the compute node encountering the error needs to be restarted because the other compute nodes would not be affected by an error that occurs during a local calculation. In contrast, however, the application error handler may determine that the application on a particular compute node is performing a communications operation when the recoverable error occurs. In this example, the application error handler would determine that all of the compute nodes involved in the communications would need to be restarted.

The method of FIG. 6 also includes restarting (614), by each of the affected compute nodes (612), execution of the application. Restarting (614), by each of the affected compute nodes (612), execution of the application according to the method of FIG. 6 is initiated by the error handler of the application on the compute node encountering the recoverable error (608). After determining the affected compute nodes (612), the application error handler instructs (616) the operating system on the compute node encountering the recoverable error (608) to notify the operating systems executing on the affected compute nodes (612) to restart execution of the application. The operating systems executing on the affected compute nodes (612), in turn, may receive the restart notifications (618) from the operating system on the node encountering the recoverable error (608) and reset the hardware component affected by the recoverable error (608). The operating systems executing on the affected compute nodes (612) may reset the hardware component affected by the recoverable error (608) by cycling the power to those components and then rescheduling the application for execution on those affected compute node (612) from the beginning of the application's execution sequence.

The method of FIG. 6 includes retrieving (620), by the restarted application executing on each of the affected compute nodes (612), the application restore data (602) from the restore buffer (203). The restarted application executing on each of the affected compute nodes (612) retrieves (620) the application restore data (602) from the restore buffer (203) according to the method of FIG. 6 by requesting (622) the location of the restore buffer (203) from the operating system executing on each of the affected compute nodes (612) and receiving (626) the location (628) of the restore buffer in response to the request (624). The restarted application may request (622) the location of the restore buffer (203) from the operating system executing on each of the affected compute nodes (612) according to the method of FIG. 6 by invoking a function of the operating system's API. The restarted application may receive (626) the location (628) of the restore buffer in response to the request (624) according to the method of FIG. 6 as a return value from the invoked function or through variable provided to the operating system as an argument of the invoked function. Readers will note that between the time that the recoverable error was encountered and the time that the application restarts and requests the location of the restore buffer (203), the operating system may move the restore buffer (203) to a different area of the node's computer memory. However, moving the restore buffer (203) does not affect the ability of the compute node to continue executing the application using the information in the restore buffer (203) because the application requests the location (628) of the buffer (203) from the operating system upon restarting.

The method of FIG. 6 includes continuing (632), by each affected compute node (612), execution of the application with the execution state specified by the retrieved application restore data. Each affected compute node (612) continues (632) execution of the application with the execution state specified by the retrieved application restore data (602) according to the method of FIG. 6 by configuring the contents of hardware registers, cache, computer memory, or the like used by or on behalf of the application with the retrieved application restore data (602) and scheduling the application for execution on the processors of the affected compute nodes (612). In such a manner, the affected compute nodes (612) continue execution of the application at the predetermined execution point reached before the recoverable error (608) was encountered. Error recovery during execution of an application on a parallel computer according to embodiments of the present invention therefore advantageously restarts and restores application execution on only the affected compute node at a point before the recoverable error occurs-rather than restarting application execution from the beginning on all of the compute nodes of the parallel computer regardless of whether or not those nodes were affected by the recoverable error.

Exemplary embodiments of the present invention are described largely in the context of a fully functional computer system for error recovery during execution of an application on a parallel computer. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of error recovery during execution of an application on a parallel computer, the parallel computer including a plurality of compute nodes, the method comprising:
storing, by the application during execution on the compute nodes, application restore data in a restore buffer at predetermined points during execution of the application, the application restore data specifying an execution state of the application at one or more points during execution of the application;
encountering, by at least one of the compute nodes executing the application, a recoverable error during execution of the application;
determining, by the application, the compute nodes affected by the recoverable error;
restarting, by each of the affected compute nodes, execution of the application;
retrieving, by the restarted application executing on each of the affected compute nodes, the application restore data from the restore buffer; and
continuing, by each affected compute node, execution of the application with the execution state specified by the retrieved application restore data.

2. The method of claim 1 wherein the restore buffer is located in static memory.

3. The method of claim 1 wherein retrieving, by the restarted application executing on each of the affected compute nodes, the application restore data from the restore buffer further comprises:
requesting the location of the restore buffer from the operating system executing on each of the affected compute nodes; and
receiving the location of the restore buffer in response to the request.

4. The method of claim 1 wherein restarting, by each of the affected compute nodes, execution of the application further comprises instructing, by the application on the compute node encountering the recoverable error, the operating system on the compute node encountering the recoverable error to notify the operating systems executing on the affected compute nodes to restart execution of the application.

5. The method of claim 1 wherein encountering, by at least one of the compute nodes executing the application, a recoverable error during execution of the application further comprises resetting hardware components affected by the recoverable error.

6. The method of claim 1 wherein the plurality of compute nodes are connected using a plurality of data communications networks, at least one of the data communications networks optimized for point to point operations, and at least one of the data communications networks optimized for collective operations.

7. A parallel computer capable of error recovery during execution of an application on the parallel computer, the parallel computer including a plurality of compute nodes, the parallel computer comprising a plurality of computer processors and computer memory operatively coupled to the computer processors, the computer memory having disposed within it computer program instructions capable of:
storing, by the application during execution on the compute nodes, application restore data in a restore buffer at predetermined points during execution of the application, the application restore data specifying an execution state of the application at one or more points during execution of the application;
encountering, by at least one of the compute nodes executing the application, a recoverable error during execution of the application;
determining, by the application, the compute nodes affected by the recoverable error;
restarting, by each of the affected compute nodes, execution of the application;
retrieving, by the restarted application executing on each of the affected compute nodes, the application restore data from the restore buffer; and
continuing, by each affected compute node, execution of the application with the execution state specified by the retrieved application restore data.

8. The parallel computer of claim 7 wherein the restore buffer is located in static memory.

9. The parallel computer of claim 7 wherein retrieving, by the restarted application executing on each of the affected compute nodes, the application restore data from the restore buffer further comprises:
requesting the location of the restore buffer from the operating system executing on each of the affected compute nodes; and
receiving the location of the restore buffer in response to the request.

10. The parallel computer of claim 7 wherein restarting, by each of the affected compute nodes, execution of the application further comprises instructing, by the application on the compute node encountering the recoverable error, the operating system on the compute node encountering the recoverable error to notify the operating systems executing on the affected compute nodes to restart execution of the application.

11. The parallel computer of claim 7 wherein encountering, by at least one of the compute nodes executing the application, a recoverable error during execution of the application further comprises resetting hardware components affected by the recoverable error.

12. The parallel computer of claim 7 wherein the plurality of compute nodes are connected using a plurality of data communications networks, at least one of the data communications networks optimized for point to point operations, and at least one of the data communications networks optimized for collective operations.

13. A computer program product for error recovery during execution of an application on a parallel computer, the parallel computer including a plurality of compute nodes, the computer program product disposed upon a computer readable medium, the computer program product comprising computer program instructions capable of:
storing, by the application during execution on the compute nodes, application restore data in a restore buffer at predetermined points during execution of the application, the application restore data specifying an execution state of the application at one or more points during execution of the application;
encountering, by at least one of the compute nodes executing the application, a recoverable error during execution of the application;
determining, by the application, the compute nodes affected by the recoverable error;
restarting, by each of the affected compute nodes, execution of the application;
retrieving, by the restarted application executing on each of the affected compute nodes, the application restore data from the restore buffer; and
continuing, by each affected compute node, execution of the application with the execution state specified by the retrieved application restore data.

14. The computer program product of claim 13 wherein the restore buffer is located in static memory.

15. The computer program product of claim 13 wherein retrieving, by the restarted application executing on each of the affected compute nodes, the application restore data from the restore buffer further comprises:
requesting the location of the restore buffer from the operating system executing on each of the affected compute nodes; and
receiving the location of the restore buffer in response to the request.

16. The computer program product of claim 13 wherein restarting, by each of the affected compute nodes, execution of the application further comprises instructing, by the application on the compute node encountering the recoverable error, the operating system on the compute node encountering the recoverable error to notify the operating systems executing on the affected compute nodes to restart execution of the application.

17. The computer program product of claim 13 wherein encountering, by at least one of the compute nodes executing the application, a recoverable error during execution of the application further comprises resetting hardware components affected by the recoverable error.

18. The computer program product of claim 13 wherein the plurality of compute nodes are connected using a plurality of data communications networks, at least one of the data communications networks optimized for point to point operations, and at least one of the data communications networks optimized for collective operations.

19. The computer program product of claim 13 wherein the computer readable medium comprises a recordable medium.

20. The computer program product of claim 13 wherein the computer readable medium comprises a transmission medium.
